(19) United States
(12) Patent Application Publication
(10) Pub. No.: US 2026/0288982 A1
(43) Pub. Date: Sep. 24, 2026

(54) METHOD, APPARATUS, DEVICE AND STORAGE MEDIUM FOR PERMISSION MANAGEMENT

(71) Applicants: Beijing Zitiao Network Technology Co., Ltd., Beijing (CN); Lemon Inc., Grand Cayman (KY)

(72) Inventors: Yulin Deng, Beijing (CN); Yi Zhang, Los Angeles, CA (US); Jun Ge, Beijing (CN); Lei Wang, Beijing (CN); Zhangyi Chen, Beijing (CN); Yi Zhao, Beijing (CN)

(21) Appl. No.: 19/477,765

(22) PCT Filed: May 17, 2024
(86) PCT No.: PCT/CN2024/094082

§ 371 Date: Oct. 22, 2025

(30) Foreign Application Priority Data
May 19, 2023 (CN) 202310576864.7

(51) Int. Cl. G06F 21/60; G06F 21/45

(52) U.S. Cl. CPC G06F 21/604; G06F 21/45

(57) ABSTRACT

A method, apparatus, device and storage medium for permission management are provided. In a method, a permission management request for a target application is received. The permission management request indicates one or more permission configurations of the target application. A first prompt input is generated based at least on the permission management request and description information of the target application that is related to permission management. First permission information related to a target permission configuration of one or more permission configurations is determined based on the first prompt input with the model. The first permission information indicates an operation for the target permission configuration or a check result for the target permission configuration.

This application claims the benefit of Chinese Patent Application No. 202310576864.7, entitled “METHOD, APPARATUS, DEVICE AND STORAGE MEDIUM FOR PERMISSION MANAGEMENT”, filed May 19, 2023, the entirety of which is incorporated herein by reference.

### FIELD

Example embodiments of the present disclosure generally relate to the field of computers, and in particular, to a method, apparatus, device, and computer readable storage medium for permission management.

### BACKGROUND

With the development of computer technologies, more and more applications provide services for people in various aspects of work and life. To deploy more applications conveniently and quickly, an application management platform appears. The application management platform may perform operations such as building, deploying, using, updating, and managing applications, so as to provide an application meeting a user requirement to a user.

### SUMMARY

In a first aspect of the present disclosure, a method of permission management is provided. The method includes: receiving a permission management request for a target application, the permission management request indicating one or more permission configurations of the target application; generating a first prompt input based at least on the permission management request and description information of the target application that is related to permission management; and determining, with a model and based on the first prompt input, first permission information related to a target permission configuration of the one or more permission configurations, the first permission information indicating an operation for the target permission configuration or a check result for the target permission configuration.

In a second aspect of the present disclosure, an apparatus for permission management is provided. The apparatus includes: a request reception module, configured to receive a permission management request for a target application, the permission management request indicating one or more permission configurations of the target application; a prompt generation module, configured to generate a first prompt input based at least on the permission management request and description information of the target application that is related to permission management; and a permission information determination module, configured to determine, with a model and based on the first prompt input, first permission information related to a target permission configuration of the one or more permission configurations, the first permission information indicating an operation for the target permission configuration or a check result for the target permission configuration.

In a third aspect of the present disclosure, there is provided an electronic device. The device includes at least one processor; and at least one memory coupled to the at least one processor and storing instructions executable by the at least one processor. The instructions, when executed by the at least one processor, cause the device to perform the method of the first aspect.

In a fourth aspect of the present disclosure, there is provided a computer readable storage medium having stored thereon a computer program executable by a processor to implement the method of the first aspect.

It should be understood that the content described in the SUMMARY section is neither intended to limit key features or important features of embodiments of the present disclosure, nor is it intended to limit the scope of the present disclosure. Other features of the present disclosure will be readily understood from the following description.

### BRIEF DESCRIPTION OF DRAWINGS

The above and other features, advantages and aspects of embodiments of the present disclosure will become more apparent with reference to the following DETAILED DESCRIPTION taken in conjunction with the accompanying drawings. In the drawings, the same or similar reference numerals represent the same or similar elements, wherein:

FIG. 1 illustrates a schematic diagram of an example environment in which embodiments of the present disclosure can be implemented;

FIGS. 2A to 2C illustrate schematic diagrams of example session windows according to some embodiments of the present disclosure;

FIG. 3 illustrates an example of information required to generate a prompt input according to some embodiments of the present disclosure;

FIG. 4 illustrates a flowchart of a method of permission management according to some embodiments of the present disclosure;

FIG. 5 illustrates a block diagram of an apparatus for permission management according to some embodiments of the present disclosure; and

FIG. 6 illustrates a block diagram of a device capable of implementing a plurality of embodiments of the present disclosure.

### DETAILED DESCRIPTION

It can be understood that, before using the technical solutions disclosed in the embodiments of the present disclosure, the user should be notified of the type, the use range, the use scenario, and the like of the personal information involved in the present disclosure and authorized by the user in an appropriate manner according to related laws and regulations.

For example, when an active request of a user is received, prompt information is sent to the user to explicitly prompt the user, and an operation requested to be performed by the user needs to obtain and use personal information of the user. Therefore, the user can autonomously select, according to the prompt information, whether to provide personal information to software or hardware such as an electronic device, an application, a server or a storage medium that performs the operations of the technical solutions of the present disclosure.

As an optional but non-limiting implementation manner, in response to receiving an active request of the user, a manner of sending prompt information to the user, for example, a manner of popping up a window, the pop-up window may present the prompt information in a text manner. In addition, the pop-up window may further carry a selection control for the user to select “agree” or “disagree” to provide personal information to the electronic device.

It should be understood that the foregoing process of notifying and acquiring user authorization is merely illustrative and does not constitute a limitation on the implementations of the present disclosure, and other manners that meet related laws and regulations may also be applied to the implementations of the present disclosure.

It can be understood that data (including but not limited to the data itself, the acquisition or use of the data) involved in this technical solution should comply with requirements of corresponding laws and regulations and related rules.

The term “in response to” as used herein represents a state in which a respective event occurs, or condition is satisfied. It will be appreciated that the timing of execution of a subsequent action performed in response to an event or condition is not necessarily strongly correlated with the time at which the event occurs, or the condition holds. For example, in some cases, the subsequent action may be performed immediately when the event occurs or the condition holds; while in other cases, the subsequent action may be performed after a period of time elapses after the event occurs or the condition holds.

The embodiments of the present disclosure will be described in more detail below with reference to the accompanying drawings. Although some embodiments of the present disclosure are shown in the drawings, it should be understood that the present disclosure may be implemented in various forms and should not be construed as being limited to the embodiments set forth herein. Rather, these embodiments are provided for a more thorough and complete understanding of the present disclosure. It should be understood that the drawings and embodiments of the present disclosure are only for illustrative purposes and are not intended to limit the scope of protection of the present disclosure.

It should be noted that titles of any section/subsection provided herein are not limiting. Various embodiments are described throughout this document, and any type of embodiment may be included under any section/subsection. Moreover, the embodiments described in any section/subsection may be combined in any manner with any other embodiments described in the same section/subsection and/or different section/subsection.

In the description of the embodiments of the present disclosure, the term “include” and similar terms should be understood as open inclusion, that is, “include but not limited to”. The term “based on” should be understood as “at least partially based on”. The term “an embodiment” or “the embodiment” should be understood as “at least one embodiment”. The term “some embodiments” should be understood as “at least some embodiments”. Other explicit and implicit definitions may also be included below. The terms first”, “second”, etc. may refer to different or the same objects. Other explicit and implicit definitions may also be included below.

As used herein, the term “permission configuration” refers to setting data that one or more roles in an application can access and/or operations they can perform. The “permission configuration” may also be referred to as a “permission configuration scheme”.

As briefly mentioned above, the application management platform may help the user manage the application. In a full-link application management platform, a module related to permission management is usually included. Such a module provides a flexible configuration manner to meet various types of permissions and security management rules in actual applications. For example, some types of data can only allow a certain group of users to access, or some functions can only be visible to employees of a department. However, such permission configuration work is usually fine and complicated, and it is very easy to make mistakes or miss configurations in the configuration process of the long link, thereby causing security vulnerabilities.

A user may interact with an application using natural language, while the application may interact with a model through a natural language interface due to more accurate semantic understanding capabilities and contextual reasoning capabilities brought by the model, such as a machine learning model. In this case, it is expected that the model can at least partially assist people in creating, modifying, and checking permission configurations.

To this end, the embodiments of the present disclosure provide a solution for permission management. According to various embodiments of the present disclosure, a permission management request for a target application is received. The permission management request indicates one or more permission configurations of the target application. A first prompt input is generated based at least on the permission management request and description information of the target application that is related to permission management. First permission information related to a target permission configuration of one or more permission configurations is determined based on the first prompt input with the model. The first permission information indicates an operation for the target permission configuration or a check result for the target permission configuration.

Therefore, management of the permission configuration can be implemented using the model. For example, a model may be used to implement the creation of a new permission configuration scheme, modification of an existing permission configuration scheme, and the like, which advantageously improves efficiency of permission configuration creation and modification. For another example, the existing permission configuration may be checked using the model, which is beneficial to finding possible security vulnerabilities in time. In this way, the complexity of permission management can be reduced on the premise of keeping the flexibility of the permission configuration, and the efficiency of permission management is improved.

The example embodiments of the present disclosure are described below with reference to the accompanying drawings.

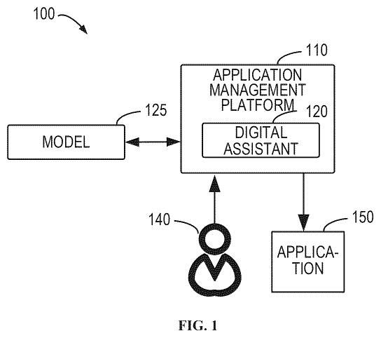

FIG. 1 illustrates a schematic diagram of an example environment 100 in which embodiments of the present disclosure can be implemented. In the environment 100, an application management platform 110 may be used by a user 140 who is expected to manage applications to manage an application 150. For example, the permission configuration of the application 150 may be created, modified, or checked, etc. In some embodiments, the application management platform 110 may also be considered an application that provides application management services.

The application management platform 110 is configured with a digital assistant 120 that may interact with the user 140 to obtain information from and/or provide information to the user 140. For example, the application management platform 110 may provide the user 140 with a session window for interacting with the digital assistant 120. Accordingly, the user 140 may interact with the digital assistant 120 in the session window, such as inputting a session message, receiving feedback content of the digital assistant for the session message, and the like. The interaction between the user 140 and digital assistant 120 and/or the application management platform 110 may be performed in any suitable manner. In some implementations, a user input in the interaction may include input in a multimodal form, such as text input (e.g., input in natural language form), voice input, image input, video input, and so forth.

In the embodiments of the present disclosure, the digital assistant 120 is used for dialogue with the user 140. An interaction window, such as a session window, between the user 140 and the digital assistant 120 is presented in a client interface. The digital assistant 120, as an intelligent assistant, has an intelligent dialogue and information processing capability. In the session window, the user inputs a session message in the session window, and the digital assistant provides a reply message in response to the session message. The client interface for presenting the session window may correspond to the application management platform 110 or a multifunction collaboration platform capable of implementing application management.

The digital assistant 120 may be called or awakened in an appropriate manner (e.g., shortcut, button, or voice) to present a session window with the user 140. For example, the digital assistant 120 may be awakened or called in response to an application management request by the user 140. The session window may include interface elements for information interaction, such as input boxes, message lists, message bubbles, and the like.

In some embodiments, the application management platform 110 may utilize a model 125 to provide application management function to the user 140. In some embodiments, the model 125 may be a machine learning model, deep learning model, learning model, neural network, or the like. In some embodiments, the model 125 may be based on a language model (LM). The model 125 may also be based on other suitable models.

The model 125 may be deployed on or accessible by the application management platform 110. Alternatively, the application management platform 110 may communicate with the model 125 to provide application management services for the user 140 using the model 125. For example, the application management platform 110 may send a prompt input to the model 125 based on the interaction information between the user 140 and the digital assistant 120 and obtain a processing result from the model 125. Alternatively, or additionally, the digital assistant 120 itself may also be derived based on a model. As an example, such a digital assistant may be derived based on a multimodal model, which may process various forms of user input, including but not limited to text, voice, images, video, body language (e.g., gestures), and the like. As another example, such a digital assistant 120 may be derived based on a natural language processing model. The digital assistant 120 may process the session message input by the user 140 in a natural language to obtain a requirement of the user 140, for example, an application desired to be created by the user 140, a function implemented by the desired application, and the like. The model 125 may be configured locally or independently of the application management platform 110 according to requirements, and the present disclosure is not intended to be limited thereto.

In some embodiments, the application management platform 110 may be based on an application platform-as-a-service (aPaaS). aPaaS is a cloud service that provides an environment for the development and running of software applications. aPaaS allows developers to create large scale applications. Therefore, using the digital assistant 120, the aPaaS based platform can further reduce the requirement on the development capability of the user 140, assist the user 140 more widely to manage the target application, and improve the user experience.

In the environment 100, the application management platform 110 may be deployed in an electronic device, and the electronic device may be any type of device having computing capability, including a terminal device or a server device. The terminal device may be any type of mobile terminal, fixed terminal, or portable terminal, including a mobile phone, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/camcorder, a locating device, a television receiver, a radio broadcast receiver, an e-book device, a gaming device, or any combination of the foregoing, including accessories and peripherals of these devices, or any combination thereof. The server device may include, for example, a computing system/server, such as a mainframe, an edge computing node, a computing device in a cloud environment, or the like.

It should be understood that the structure and function of the environment 100 is described for example purposes only and does not imply any limitation to the scope of the present disclosure.

The user 140 may create and maintain an application (also referred to as a target application) through the application management platform 110. As a trigger for permission management of the target application, the application management platform 110 receives a permission management request for the target application. Such a permission management request indicates one or more permission configurations of the target application. For example, the permission management request may indicate that a new permission configuration is created for the target application. For another example, the permission management request may indicate to modify one or more existing permission configurations of the target application. For a further example, the permission management request may indicate to check one or more existing permission configurations or all permission configurations of the target application.

The user 140 is allowed to give the permission management request in any suitable form. In some embodiments, the application management platform 110 may provide or present one or more controls for the permission management, also referred to as permission management controls. If a trigger for the permission management control is detected, for example, the user 140 clicks a certain permission management control, the permission management request is received. For example, the permission management control may include a control for creating a new permission configuration scheme. If the control is clicked, the application management platform 110 receives a request to create a new permission configuration.

In some embodiments, the permission management request may be represented in natural language. For example, the application management platform 110 may receive a session message represented in natural language. The session message may include one or more user inputs and may be in the form of text, voice, or a combination thereof. Such a session message may indicate one or more permission configurations to create, modify, and check the target application.

Alternatively, or additionally, in some embodiments, the permission management request may also be in other forms. For example, the permission management request may be expressed in body language (e.g., gesture). For another example, the permission management request may be expressed in a multimedia form such as video, audio, and image.

For example, when the user 140 desires to perform the permission configuration of the target application, the user 140 may provide a message represented in the natural language to the application management platform 110 in a form such as text, voice, or the like, to instruct the application management platform 110 to give the permission configuration scheme or perform the permission configuration. For example, the session message may be “help me create a permission configuration scheme”. Similarly, where the user 140 desires to modify the permission configuration, the user 140 may provide a session message such as “help me modify existing permission settings” to instruct the application management platform 110 to modify the created permission configuration. That is, such a session message includes a permission management request.

In some embodiments, the permission management request may be received in a session window between the user 140 and the digital assistant 120. For example, the application management platform 110 may provide a session window with the digital assistant 120 to the user 140 and present an input box in the session window for the user 140 to provide input. The input box may receive inputs in various suitable forms, such as a natural language text input, a natural language voice input, an image, a video, a body language of the user. In this way, the user 140 may be facilitated to present his or her needs and quickly indicate its needs using the input box. Further, the application management platform 110 may obtain the session message of the user 140 using the input box, to implement interaction with the user 140.

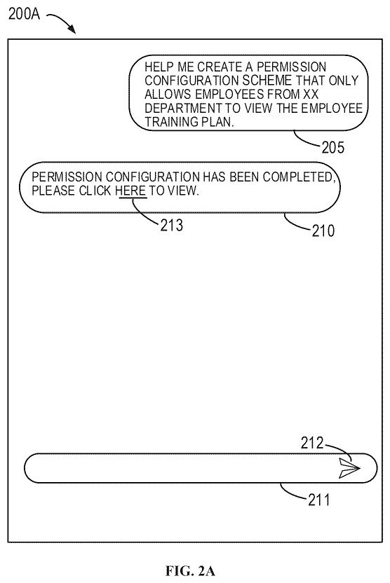

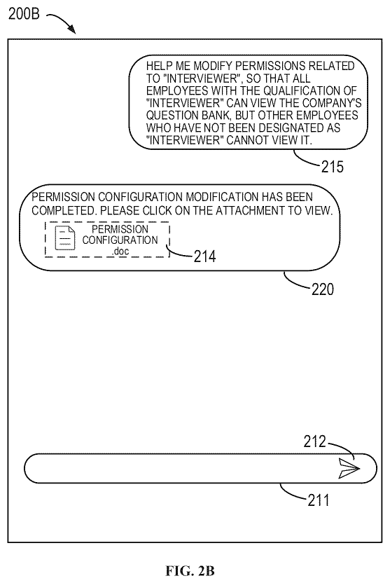

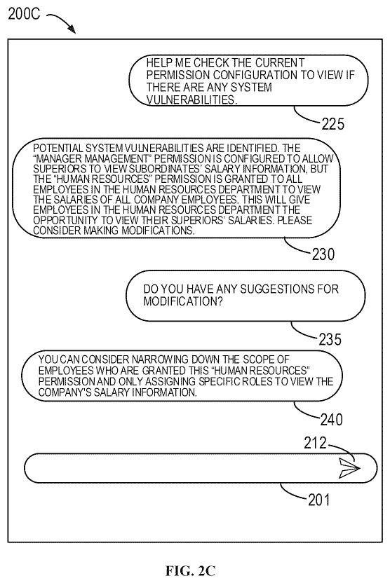

For example, refer to FIG. 2A to FIG. 2C. In the interface 200A to the interface 200C, a session window between the user 140 and the digital assistant 120 is displayed. In the session window, an input box 211 is presented for the user 140 to provide input. For example, after inputting a text in the input box 211, the user 140 may trigger a control 212 (for example, by clicking the control 212) to send the text.

In the example of FIG. 2A, the user 140 desires to create a permission configuration scheme for the target application. The application management platform 110 receives a session message 205, for example, “Help me create a permission configuration scheme that only allows employees from XX department to view the employee training plan”. By parsing the session message 205, it may be determined that a permission management request for creating a new permission configuration is received.

In the example of FIG. 2B, the user 140 desires to modify one permission setting of the target application. The application management platform 110 receives a session message 215, such as “help me modify permissions related to “interviewer”, so that all employees with the qualification of “interviewer” can view the company's question bank, but other employees who have not been designated as “interviewer” cannot view it”. By parsing the session message 215, it may be determined that a permission management request for modifying the existing permission configuration is received.

In the example of FIG. 2C, the user 140 expects to check an existing permission configuration scheme in the target application to find an unreasonable configuration or a potential security vulnerability. The application management platform 110 receives a session message 225, for example, “help me check the current permission configuration to view if there are any system vulnerabilities”. By parsing the session message 225, it may be determined that a permission management request for checking the existing permission configuration is received.

In response to receiving the permission management request, such as described with reference to FIGS. 2A to 2C, the application management platform 110 generates a prompt input based at least on the permission management request and description information related to the permission configuration of the target application. Such a prompt input will be used by the model 125 to give an operation or check result for the permission configuration.

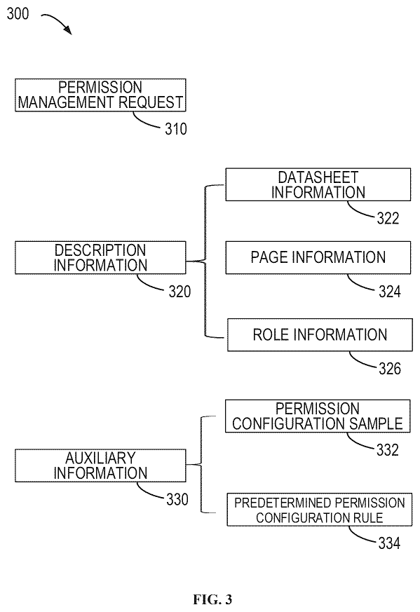

An example of information required to generate a prompt input is described below with reference to FIG. 3. In the example of FIG. 3, information that may be used to manage permission configurations is listed. As shown in FIG. 3, the prompt input may be generated based on a permission management request 310. For example, the prompt input may be generated using a session message including the permission management request 310, such as session messages 205, 215, 225, or a predetermined text corresponding to the permission management request 310.

Description information 320 may include basic information related to the permission management of the target application. The description information 320 may be considered as an application context of the target application. By way of example and not by way of limitation, FIG. 3 illustrates that the description information 320 includes datasheet information 322, page information 324, and role information 326.

The datasheet information 322 may include information related to one or more datasheets in the target application. For example, with respect to a certain datasheet, the datasheet information 322 may include a general description of the datasheet, a table structure description, a datasheet script, and the like. The general description may be used to describe an overview of the content recorded by the datasheet, the use of the datasheet, and the like. The table structure description may, for example, describe which fields are included in the datasheet, field names, data types and field descriptions of each field, and the like.

The page information 324 may include information related to one or more pages in the target application. For example, for a certain page, the page information 324 may describe which datasheets are contained in the page, the involved flows, and the like.

The role information 326 may, for example, describe which roles are set in the target application, the permission of each role, and the like. If the permission configuration indicated by the permission management request is an existing permission configuration (for example, in a case where the permission configuration is modified or checked), the role information 326 may further describe a permission that each role has been given, a user that is given the role, and the like.

In some embodiments, the model 125 may already have the ability of permission configuration. In such embodiments, the prompt input may be generated directly based on the permission management request 310 and the description information 320.

In some embodiments, if it is desired to be able to give more information to the model 125, a prompt input may additionally be generated based on auxiliary information 330 associated with the permission configuration. The application management platform 110 determines the prompt input based on the permission management request 310, the description information 320, and the auxiliary information 330.

The auxiliary information 330 may include a permission configuration scheme that may be employed by the target application or other application. In some embodiments, the auxiliary information 330 may include one or more permission configuration samples 332 and/or predetermined permission configuration rules 334.

Each permission configuration sample may include one or more roles and permissions corresponding to each role. For the example of FIG. 2B, the permission configuration sample may come from another application of the same type with respect to the permission settings for the roles of “interviewer” and “interview administrator”. The “interview administrator” role has the permission to create, delete, modify, and view test questions. The “interviewer” role only has the permission to view the test questions. The “other” roles do not have the permissions described above.

The permission configuration sample may include a positive sample and/or a negative sample. The permission of each role in the positive sample is set correctly, and the permission of at least one role in the negative sample is set incorrectly. In particular, if the permission management request 310 is a request to check the existing permission configuration, a negative sample may be used. In this case, it is necessary to identify whether the sample is a positive sample or a negative sample for each permission configuration sample in the prompt input.

The predetermined permission configuration rule may be set according to employee posts, department function, and the like in the organization. The permission may be divided into functional permission and data permission. The functional permission may be a global permission rule, such as viewing documents, printing documents, sending documents, and so forth. The data permission relates to rules how to process department and role data sharing, such as which data can be viewed, which data can be processed, and so forth.

Based on the permission management request 310, the description information 320, and the optional auxiliary information 330, the application management platform 110 may generate the prompt input. The prompt input may directly include the permission management request, the description information, and/or the auxiliary information, or the information may be preprocessed to generate the prompt input. The preprocessing includes, for example, sorting information, adjusting formats or adding associated prompts, and the like.

Then, the application management platform 110 determines, using the model 125, permission information related to the target permission configuration based on the prompt input. The permission information indicates an operation for the target permission configuration or a check result for the target permission configuration. In some embodiments, the application management platform 110 may provide the generated prompt input to the model 125. The model 125 receives the prompt input and generates the permission information based on the prompt input. The application management platform 110 may obtain permission information from the model 125.

In some embodiments, the permission information may be presented to the user 140 in the session window between the user 140 and the digital assistant 120.

For example, if the permission management request indicates to create the target permission configuration, the permission information indicates one or more operations that may be used to create the target permission configuration. In the example of FIG. 2A, based on such permission management request, the application management platform 110 may return a corresponding permission configuration scheme using the model 125, for example, return the session message 210 “permission configuration has been completed, please click here to view”. Such a session message not only includes reply information for the execution result but may also include a specific permission configuration scheme attached in the form of a hyperlink 213.

For another example, if the permission management request indicates to modify the target permission configuration, the permission information indicates one or more operations that may be used to modify the target permission configuration. In the example of FIG. 2B, based on such a permission management request, the application management platform 110 may return a corresponding permission configuration scheme using the model 125, for example, return the session message 220 “permission configuration modification has been completed, please click on the attachment to view”. Such a session message not only includes reply information for the execution result but may also include a specific permission configuration scheme attached in the form of an accessory 214.

For a further example, if the permission management request indicates to check one or more permission configurations of the target application, the permission information may indicate a check result for the target permission configuration. For example, the check result may indicate that the target permission configuration has no vulnerability or may indicate a vulnerability or a potential safety hazard that may exist in the target permission configuration. In the example of FIG. 2C, based on such a permission management request, the application management platform 110 may return a corresponding check result using the model 125, for example, the session message 230 “Potential system vulnerabilities are identified. The ‘manager management’ permission is configured to allow superiors to view subordinates' salary information, but the ‘human resources’ permission is granted to all employees in the human resources department to view the salaries of all company employees. This will give employees in the human resources department the opportunity to view their superiors' salaries. Please consider making modifications”. Such session messages may include execution results and detailed analysis.

The permission information may be represented in any suitable form, such as natural language or machine-executable code. To this end, in some embodiments, the prompt input further indicates how the model 125 provides the permission information. For example, if it is desired that the model 125 returns the permission information represented in the natural language, the prompt input may indicate that the model 125 provides the permission information in a natural language manner. For example, in the examples of FIGS. 2A to 2C, the permission information is included in session information 210, session information 220, and session information 230, i.e., each presented to the user 140 in a natural language manner.

Additionally, or alternatively, the prompt input indicates the model 125 to provide the permission information in machine executable code manner. Such machine executable code may be used directly to modify or refine the code of the target application. For example, the model 125 may output intermediate language code, such as code for domain specific language (DSL), that may be used by the application management platform 110. DSL is a development language designed for a particular task for generating simple text forms of artifacts, such as source code, database scripts, and the like.

In some embodiments, the application management platform 110 may perform multi-round interaction with the user 140 through the digital assistant 120, to obtain an execution result that is more consistent with the user's expectations. In some embodiments, the application management platform 110 receives user feedback for the permission information. Such user feedback indicates further processing of the permission configuration. In the example of FIG. 2C, the application management platform 110 first receives a permission management request (e.g., the session message 225) of the user 140, and provides the generated first prompt input to the model 125. The application management platform 110 presents the first permission information returned (e.g., the session message 230) to the user 140. Further, the application management platform 110 may receive user feedback of the user 140 (e.g., the session message 235 “do you have any suggestions for modification?”. The generated second prompt input is provided to the model 125. The application management platform 110 presents the returned second permission information (for example, the session message 240 “you can consider narrowing down the scope of employees who are granted this ‘human resources’ permission and only assigning specific roles to view the company's salary information”) to the user 140.

In summary, according to various embodiments of the present disclosure, the model 120 may be utilized to provide the user with the creation, modification, or check of the permission configuration scheme. In this way, on the premise of maintaining the flexibility of the permission configuration, the complexity of permission management can be reduced, and the system security vulnerability can be found in time.

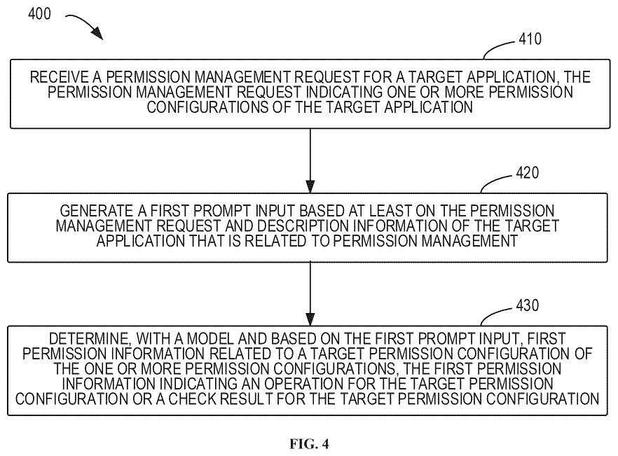

FIG. 4 illustrates a flowchart of a method 400 for permission management according to some embodiments of the present disclosure. The method 400 may be implemented at the application management platform 110. The method 400 is described below with reference to FIG. 1.

At block 410, the application management platform 110 receives a permission management request for a target application, the permission management request indicating one or more permission configurations of the target application.

At block 420, a first prompt input is generated based at least on the permission management request and description information of the target application that is related to permission management.

At block 430, first permission information related to a target permission configuration of one or more permission configurations is determined based on the first prompt input with a model, and the first permission information indicates an operation for the target permission configuration or a check result for the target permission configuration.

In some embodiments, the application management platform 110 obtains auxiliary information associated with a permission configuration; and determines the first prompt input based on the permission management request, the description information, and the auxiliary information.

In some embodiments, the auxiliary information includes at least one of: at least one permission configuration sample, a permission configuration sample comprising one or more roles and respective permissions of the one or more roles, or a set of predetermined permission configuration rules.

In some embodiments, the first prompt input indicates the model to provide the first permission information with at least one of: natural language, or machine executable code.

In some embodiments, the permission management request indicates creation of the target permission configuration, and the first permission information indicates one or more operations for creating the target permission configuration.

In some embodiments, the permission management request indicates to check the one or more permission configurations, and the first permission information indicates the check result for the target permission configuration.

In some embodiments, the application management platform 110 receives user feedback for the permission information, the user feedback indicating further processing for the checking result; determines a second prompt input based at least on the user feedback and the description information; and generates, with the model and based on the second prompt input, second permission information related to the target permission configuration, the second permission information indicating an update to the target permission configuration.

In some embodiments, the application management platform 110 provides the first prompt input to the model; and obtains the first permission information from the model.

In some embodiments, receiving the permission management request includes at least one of: receiving a trigger on a permission management control, or receiving a session message in natural language.

In some embodiments, the permission management request is received in a session window between a user and a digital assistant, and the application management platform 110 presents, in the session window, the first permission information or an indication of the first permission information.

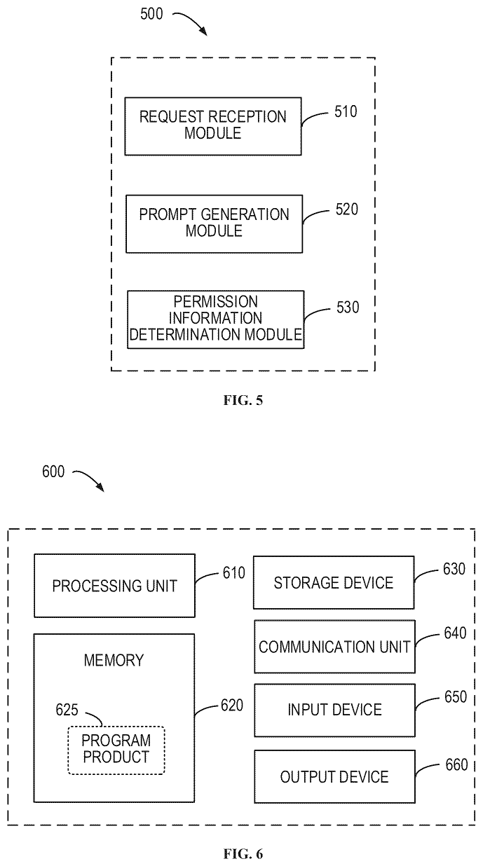

FIG. 5 is a schematic structural block diagram of an apparatus 500 for permission management according to some embodiments of the present disclosure. The apparatus 500 may be implemented or included in the application management platform 110. The various modules/components in the apparatus 500 may be implemented by hardware, software, firmware, or any combination thereof.

As shown, the apparatus 500 includes a request reception module 510 configured to receive a permission management request for a target application, the permission management request indicating one or more permission configurations of the target application. The apparatus 500 further includes a prompt generation module 520 configured to generate a first prompt input based at least on the permission management request and description information of the target application that is related to permission management. The apparatus 500 further includes a permission information determination module 530 configured to determine, with a model and based on the first prompt input, first permission information related to a target permission configuration of the one or more permission configurations, the first permission information indicating an operation for the target permission configuration or a check result for the target permission configuration.

In some embodiments, the prompt generation module 520 is configured to obtain auxiliary information associated with a permission configuration; and determine the first prompt input based on the permission management request, the description information, and the auxiliary information.

In some embodiments, the auxiliary information comprises at least one of: at least one permission configuration sample, a permission configuration sample comprising one or more roles and respective permissions of the one or more roles, or a set of predetermined permission configuration rules.

In some embodiments, the first prompt input indicates the model to provide the first permission information with at least one of: natural language, or machine executable code.

In some embodiments, the permission management request indicates creation of the target permission configuration, and the first permission information indicates one or more operations for creating the target permission configuration.

In some embodiments, the permission management request indicates to check the one or more permission configurations, and the first permission information indicates the check result for the target permission configuration.

In some embodiments, the apparatus 500 further includes: a user feedback reception module configured to receive user feedback for the permission information, the user feedback indicating further processing for the checking result; a second prompt generation module configured to determine a second prompt input based at least on the user feedback and the description information; and a second permission information generation module configured to generate, with the model and based on the second prompt input, second permission information related to the target permission configuration, the second permission information indicating an update to the target permission configuration.

In some embodiments, the permission information determination module is configured to provide the first prompt input to the model; and obtain the first permission information from the model.

In some embodiments, receiving the permission management request includes at least one of: receiving a trigger on a permission management control, or receiving a session message in natural language.

In some embodiments, the permission management request is received in a session window between a user and a digital assistant, and the apparatus 500 further includes a presentation module configured to present, in the session window, the first permission information or an indication of the first permission information.

FIG. 6 illustrates a block diagram of an electronic device 600 in which one or more embodiments of the present disclosure may be implemented. It should be understood that the electronic device 600 shown in FIG. 6 is only an example and should not constitute any limitation on the functionality and scope of the embodiments described herein. The electronic device 600 as shown in FIG. 6 may be used to implement the application management platform 110 in FIG. 1.

As shown in FIG. 6, the electronic device 600 is in the form of a general computing device. The components of electronic device 600 may include, but are not limited to, one or more processors or processing units 610, a memory 620, a storage device 630, one or more communication units 640, one or more input devices 650, and one or more output devices 660. The processing unit 610 may be an actual or virtual processor and can execute various processes based on the programs stored in the memory 620. In a multiprocessor system, multiple processing units execute computer executable instructions in parallel to improve the parallel processing capability of the electronic device 600.

The electronic device 600 typically includes multiple computer storage medium. Such medium may be any available medium that is accessible to the electronic device 600, including but not limited to volatile and non-volatile medium, removable and non-removable medium. The memory 620 may be volatile memory (for example, a register, cache, a random access memory (RAM)), a non-volatile memory (for example, a read-only memory (ROM), an electrically erasable programmable read-only memory (EEPROM), a flash memory), or any combination thereof. The storage device 630 may be any removable or non-removable medium, and may include a machine readable medium such as a flash drive, a disk, or any other medium, which may be used to store information and/or data and may be accessed within the electronic device 600.

The electronic device 600 may further include additional removable/non-removable, volatile/non-volatile storage medium. Although not shown in FIG. 6, a disk driver for reading from or writing to a removable, non-volatile disk (such as a “floppy disk”), and an optical disk driver for reading from or writing to a removable, non-volatile optical disk may be provided. In these cases, each driver may be connected to the bus (not shown) by one or more data medium interfaces. The memory 620 may include a computer program product 625, which has one or more program units configured to perform various methods or acts of various embodiments of the present disclosure.

The communication unit 640 communicates with a further electronic device through the communication medium. In addition, functions of components in the electronic device 600 may be implemented by a single computing cluster or multiple computing machines, which can communicate through a communication connection. Therefore, the electronic device 600 may be operated in a networking environment using a logical connection with one or more other servers, a network personal computer (PC), or another network node.

The input device 650 may be one or more input devices, such as a mouse, a keyboard, a trackball, etc. The output device 660 may be one or more output devices, such as a display, a speaker, a printer, etc. The electronic device 600 may also communicate with one or more external devices (not shown) through the communication unit 640 as required. The external device, such as a storage device, a display device, etc., communicate with one or more devices that enable users to interact with the electronic device 600, or communicate with any device (for example, a network card, a modem, etc.) that makes the electronic device 600 communicate with one or more other electronic devices. Such communication may be executed via an input/output (I/O) interface (not shown).

According to example implementation of the present disclosure, a computer readable storage medium is provided, on which computer executable instructions are stored, wherein the computer executable instructions are executed by the processor to implement the method described above. According to example implementation of the present disclosure, a computer program product is also provided. The computer program product is physically stored on a non-transient computer-readable medium and includes computer-executable instructions, which are executed by the processor to implement the method described above.

Various aspects of the present disclosure are described herein with reference to the flow chart and/or the block diagram of the method, the apparatus, the device and the computer program product implemented in accordance with the present disclosure. It would be appreciated that each block of the flowchart and/or the block diagram and the combination of each block in the flowchart and/or the block diagram may be implemented by computer-readable program instructions.

These computer-readable program instructions may be provided to the processing units of general-purpose computers, specialized computers or other programmable data processing devices to produce a machine that generates an apparatus to implement the functions/actions specified in one or more blocks in the flow chart and/or the block diagram when these instructions are executed through the computer or other programmable data processing apparatuses. These computer-readable program instructions may also be stored in a computer-readable storage medium. These instructions enable a computer, a programmable data processing apparatus and/or other devices to work in a specific way. Therefore, the computer-readable medium containing the instructions includes a product, which includes instructions to implement various aspects of the functions/actions specified in one or more blocks in the flowchart and/or the block diagram.

The computer-readable program instructions may be loaded onto a computer, other programmable data processing apparatus, or other devices, so that a series of operational steps may be performed on a computer, other programmable data processing apparatus, or other devices, to generate a computer-implemented process, such that the instructions which execute on a computer, other programmable data processing apparatuses, or other devices implement the functions/acts specified in one or more blocks in the flowchart and/or the block diagram.

The flowchart and the block diagram in the drawings show the possible architecture, functions and operations of the system, the method and the computer program product implemented in accordance with the present disclosure. In this regard, each block in the flowchart or the block diagram may represent a part of a unit, a program segment or instructions, which contains one or more executable instructions for implementing the specified logic function. In some alternative implementations, the functions labeled in the block may also occur in a different order from those labeled in the drawings. For example, two consecutive blocks may actually be executed in parallel, and sometimes can also be executed in a reverse order, depending on the function involved. It should also be noted that each block in the block diagram and/or the flowchart, and combinations of blocks in the block diagram and/or the flowchart, may be implemented by a dedicated hardware-based system that performs the specified functions or acts, or by the combination of dedicated hardware and computer instructions.

Each implementation of the present disclosure has been described above. The above description is an example, not exhaustive, and is not limited to the disclosed implementations. Without departing from the scope and spirit of the described implementations, many modifications and changes are obvious to ordinary skill in the art. The selection of terms used in the present disclosure aims to best explain the principles, practical application or improvement of technology in the market of each implementation, or to enable other ordinary skill in the art to understand the various embodiments disclosed herein.

1. A method of permission management, comprising:
receiving a permission management request for an application, the permission management request indicating one or more permission configurations of the application;
generating a first prompt input based at least on the permission management request and description information of the application that is related to permission management; and
determining, with a model and based on the first prompt input, first permission information related to a permission configuration of the one or more permission configurations, the first permission information indicating an operation for the permission configuration or a check result for the permission configuration.

2. The method of claim 1, wherein generating the first prompt input comprises:
obtaining auxiliary information associated with the one or more permission configurations; and
determining the first prompt input based on the permission management request, the description information, and the auxiliary information.

3. The method of claim 2, wherein the auxiliary information comprises at least one of:
at least one permission configuration sample, a permission configuration sample comprising one or more roles and respective permissions of the one or more roles, or
a set of permission configuration rules.

4. The method of claim 1, wherein the first prompt input indicates the model to provide the first permission information with at least one of:
natural language, or
machine executable code.

5. The method of claim 1, wherein the permission management request indicates creation of the permission configuration, and the first permission information indicates one or more operations for creating the permission configuration.

6. The method of claim 1, wherein the permission management request indicates to check the one or more permission configurations, and the first permission information indicates the check result for the permission configuration.

7. The method of claim 6, further comprising:
receiving user feedback for the permission information, the user feedback indicating further processing for the checking result;
determining a second prompt input based at least on the user feedback and the description information; and
generating, with the model and based on the second prompt input, second permission information related to the permission configuration, the second permission information indicating an update to the permission configuration.

8. The method of claim 1, wherein determining the first permission information comprises:
providing the first prompt input to the model; and
obtaining the first permission information from the model.

9. The method of claim 1, wherein receiving the permission management request comprises at least one of:
receiving a trigger on a permission management control, or
receiving a session message in natural language.

10. The method of claim 1, wherein the permission management request is received in a session window between a user and a digital assistant, and the method further comprises:
presenting, in the session window, the first permission information or an indication of the first permission information.

11-13. (canceled)

14. An electronic device comprises:
at least one processor; and
at least one memory coupled to the at least one processor and storing instructions for execution by the at least one processor, the instructions, when executed by the at least one processor, causing the electronic device to perform acts comprising:
receiving a permission management request for an application, the permission management request indicating one or more permission configurations of the application;
generating a first prompt input based at least on the permission management request and description information of the application that is related to permission management; and
determining, with a model and based on the first prompt input, first permission information related to a permission configuration of the one or more permission configurations, the first permission information indicating an operation for the permission configuration or a check result for the permission configuration.

15. The electronic device of claim 14, wherein generating the first prompt input comprises:
obtaining auxiliary information associated with the one or more permission configurations; and
determining the first prompt input based on the permission management request, the description information, and the auxiliary information.

16. The electronic device of claim 15, wherein the auxiliary information comprises at least one of:
at least one permission configuration sample, a permission configuration sample comprising one or more roles and respective permissions of the one or more roles, or
a set of permission configuration rules.

17. The electronic device of claim 14, wherein the first prompt input indicates the model to provide the first permission information with at least one of:
natural language, or
machine executable code.

18. The electronic device of claim 14, wherein the permission management request indicates creation of the permission configuration, and the first permission information indicates one or more operations for creating the permission configuration.

19. The electronic device of claim 14, wherein the permission management request indicates to check the one or more permission configurations, and the first permission information indicates the check result for the permission configuration.

20. The electronic device of claim 19, wherein the acts further comprise:
receiving user feedback for the permission information, the user feedback indicating further processing for the checking result;
determining a second prompt input based at least on the user feedback and the description information; and
generating, with the model and based on the second prompt input, second permission information related to the permission configuration, the second permission information indicating an update to the permission configuration.

21. The electronic device of claim 14, wherein determining the first permission information comprises:
providing the first prompt input to the model; and
obtaining the first permission information from the model.

22. The electronic device of claim 14, wherein receiving the permission management request comprises at least one of:
receiving a trigger on a permission management control, or
receiving a session message in natural language.

23. A non-transitory computer readable storage medium having stored thereon a computer program executable by a processor to implement acts comprising:
receiving a permission management request for an application, the permission management request indicating one or more permission configurations of the application;
generating a first prompt input based at least on the permission management request and description information of the application that is related to permission management; and
determining, with a model and based on the first prompt input, first permission information related to a permission configuration of the one or more permission configurations, the first permission information indicating an operation for the permission configuration or a check result for the permission configuration.
